(19) United States
(12) Patent Application Publication
(10) Pub. No.: US 2013/0279319 A1
(43) Pub. Date: Oct. 24, 2013

(54) OPTICAL PICKUP DEVICE AND OPTICAL DISC DEVICE

(71) Applicants: Toshiya Matozaki, Tokyo (JP); Hironori Nakahara, Tokyo (JP); Nobuo Takeshita, Tokyo (JP)

(72) Inventors: Toshiya Matozaki, Tokyo (JP); Hironori Nakahara, Tokyo (JP); Nobuo Takeshita, Tokyo (JP)

(73) Assignee: MITSUBISHI ELECTRIC CORPORATION, Tokyo (JP)

(21) Appl. No.: 13/978,486

(22) PCT Filed: Dec. 5, 2011
(86) PCT No.: PCT/JP2011/078068

§ 371 Date: Jul. 5, 2013

(30) Foreign Application Priority Data
Jan. 21, 2011 (JP) 2011 010566

(51) Int. Cl. G11B 7/1374

(52) U.S. Cl. CPC G11B 7/1374
USPC 369/112.24

(57) ABSTRACT

An optical pickup device moves in a feed direction parallel to a radial direction of an optical disc rotating on an axis of rotation, and records or reproduces information on an information recording surface of the optical disc. The optical pickup device has a first light source that emits light of a first wavelength, a second light source that emits light of a second wavelength differing from the first wavelength, a first objective lens for focusing the light from the first light source onto the information recording surface, and a second objective lens for focusing the light from the second light source onto the information recording surface. The first and second objective lenses and the first light source are disposed in a plane that passes through the axis of rotation and is parallel to the feed direction.

### TECHNICAL FIELD

The present invention relates to an optical pickup device and optical disc device for recording or reproducing information on a recording surface of an optical disc.

### BACKGROUND ART

There are optical disc devices of the changer type that store multiple optical discs, one of which is selected for reproduction or recording (see Patent Document 1, for example).

Patent Document 1 describes a disc player having a disc storage section for storing multiple compact discs (CDs) and a reproducing means for selecting and playing one of the CDs stored therein. The reproducing means in this disc player has a rotatably mounted arm; located above the arm are a turntable onto which a CD is loaded, a spindle motor for rotating the CD via the turntable, and a pickup unit for reading information from the rotating CD.

In the above structure, when a CD is inserted to or ejected from the disc storage section, the arm occupies a standby position outside the disc storage section. To play a CD, the arm swings around an axis and moves to a playing position inside the disc storage section and the CD to be played is loaded onto the turntable and played.

There are also optical pickup devices that record or reproduce information on three types of optical discs: CDs, digital versatile discs (DVDs), and Blu-ray discs (BDs), (see Patent Document 2, for example).

Patent Document 2 describes an optical pickup device that has a short-wavelength optical unit that emits light for BDs, a long-wavelength optical unit that emits light for DVDs and CDs, a beam splitter for guiding light from the short-wavelength unit and light from the long-wavelength unit in substantially the same direction, a collimator through which light from the beam splitter passes, an actuating member that moves the collimator to correct spherical aberration of the light for BDs, a reflex mirror that reflects the light for DVDs and CDs and transmits the light for BDs, a long-wavelength objective lens that focuses light reflected from the reflex mirror onto the optical disc, a second reflex mirror that reflects the light transmitted through the first reflex mirror, and a short-wavelength objective lens that focuses the light reflected from the second reflex mirror onto the optical disc.

### PRIOR ART REFERENCES

### Patent References

Patent Document 1: Japanese Patent Application Publication No. 2005-202990
Patent Document 2: Japanese Patent Application Publication No. 2010-73229

### SUMMARY OF THE INVENTION

### Problem to be Solved by the Invention

There is, however, a desire to reduce the dimensions of an optical pickup device that records or reproduces information on an optical disc by means of two objective lenses.

For example, there is a need for downsized optical pickup devices for use in optical disc devices of the changer type that are compatible with the three types of optical discs (BD/DVD/CD) and fit into the size defined by the 1-DIN standard for automotive devices.

An object of the present invention is therefore to provide an optical pickup device and an optical disc device with reducible dimensions.

### Means for Solving the Problem

An optical pickup device according to the present invention moves in a feed direction parallel to a radial direction of an optical disc rotating around an axis of rotation, and records or reproduces information on an information recording surface of the optical disc. The optical pickup device includes a first light source for emitting light of a first wavelength, a second light source for emitting light of a second wavelength differing from the first wavelength, a first objective lens for focusing the light from the first light source onto the information recording surface, a second objective lens for focusing the light from the second light source onto the information recording surface, an optical system for guiding the light from the first and second light sources to the first and second objective lenses, respectively, and an objective lens actuator for actuating the first and second objective lenses. When seen from the direction of the axis of rotation, the first and second objective lenses and the first light source are aligned on a line that passes through the axis of rotation and is parallel to the feed direction. The lens actuator includes a movable part for holding the first and second objective lenses, a plurality of wires secured at one end to the movable part, and a support to which the plurality of wires are secured at their other ends, for displaceably supporting the movable part via the plurality of wires. The movable part and the support are aligned in a perpendicular direction orthogonal to both the direction of the axis of rotation and the feed direction, such that the plurality of wires extend in the perpendicular direction. The movable part has an upper part in which the first and second objective lenses are disposed, a first side part extending, in a direction away from the information recording surface, from an edge of the upper part facing toward the support, and a second side part extending, in the direction away from the information recording surface, from an edge of the upper part facing away from the support. The plurality of wires are secured at said one end to the first side part. The upper part, the first side part, and the second side part bound a space extending in the feed direction and having an opening facing the first light source.

An optical disc device according to the present invention includes a magazine with a storage space for storing a plurality of optical discs, a deck into which one optical disc among the plurality of optical discs is selectively loaded for recording or reproduction, and which records or reproduces information on the loaded optical disc, and a deck swinging means for swinging the deck on a deck axis of rotation, thereby moving the deck between a position outside the storage space and a position, for loading the optical disc into the deck, within the storage space. The deck includes an optical disc rotating means onto which the optical disc is loaded and which rotates the optical disc around an axis of rotation, the above optical pickup device for recording or reproducing information on the optical disc rotating around the axis of rotation, a first guide shaft for supporting the edge of the optical pickup device facing toward the storage space and guiding motion of the optical pickup device in the feed direction, and a second guide shaft for supporting the edge of the optical pickup device facing away from the storage space and guiding the motion of the optical pickup device in the feed direction.

### Effect of the Invention

The present invention can provide an optical pickup device and optical disc device with reducible dimensions.

### BRIEF DESCRIPTION OF THE DRAWINGS

FIG. 1 is a top view showing an example of the structure of an optical disc device equipped with an optical pickup device in a first embodiment.

FIG. 2 is a schematic drawing showing an example of the structure of the optical disc device equipped with the optical pickup device in the first embodiment.

FIG. 3 is a perspective view showing an example of the structure of the optical system in the optical pickup device in the first embodiment.

FIG. 4 is a perspective view showing an example of the structure of the optical pickup device in the first embodiment.

FIG. 5 is a top view showing an example of the structure of the optical pickup device in the first embodiment.

FIG. 6 is a rear view showing an example of the structure of the optical pickup device in the first embodiment.

FIG. 7 is a perspective view showing an example of the structure of the objective lens actuator and the spherical aberration correction apparatus in the optical pickup device in the first embodiment.

FIG. 8 is a schematic drawing showing the structure of the movable part of the objective lens actuator when seen from the direction of the spherical aberration correction lens.

FIG. 9 is a schematic top view of an optical disc device used to describe its dimensions.

FIG. 10 is a top view showing an example of the structure of the optical pickup device in a second embodiment.

FIG. 11 is a rear view showing an example of the structure of the optical pickup device in the second embodiment.

FIG. 12 is a perspective view showing the structure of the movable part of the objective lens actuator in a third embodiment.

FIGS. 13(a) to 13(c) are drawings showing a semiconductor laser mounted to the light source in a fourth embodiment and the radiation intensity distribution of the emitted laser light.

### MODE FOR CARRYING OUT THE INVENTION

Embodiments of the invention will be described below with reference to the drawings.

### First Embodiment

### Optical Disc Device

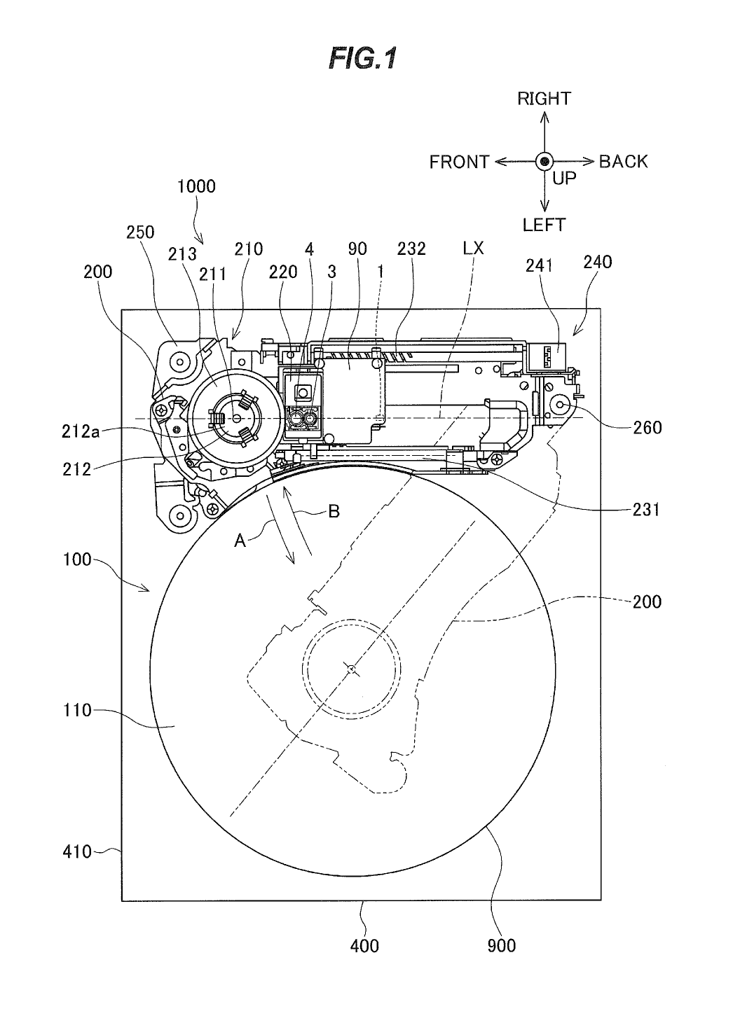

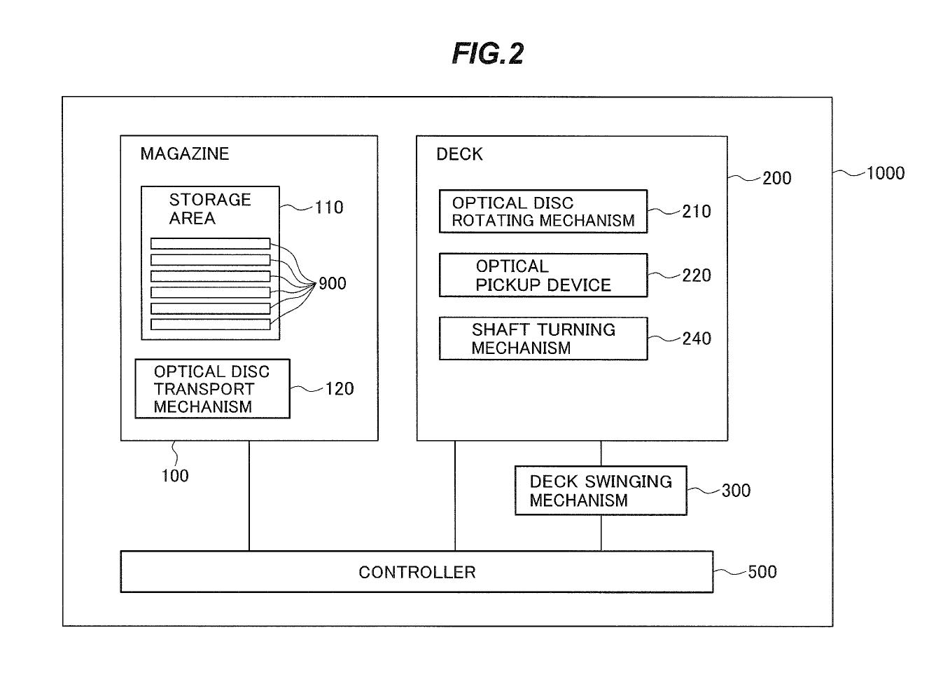

FIGS. 1 and 2 are, respectively, a top view and a schematic drawing showing an example of the structure of an optical disc device 1000 equipped with a optical pickup device 220 in the first embodiment. The optical disc device 1000 is a device with at least one of the two functions of recording and reproducing information on an optical disc 900. Here the optical disc device 1000 is a changer-type optical disc device that stores multiple optical discs 900 (this reference number will be omitted below), selects one optical disc from among the stored optical discs, and records or reproduces information on the selected optical disc. Specifically, the optical disc device 1000 is an optical disc device of the swinging deck changer type, which has a magazine 100 for storing multiple optical discs and a deck 200 in which the optical pickup device 220 is mounted, and which swings the deck 200 around a deck axis of rotation 260 to move the deck 200 into the magazine 100 or park it outside the magazine 100. The optical disc device 1000 is usable with at least two types of optical discs on which recording or reproduction is carried out with light beams of mutually differing wavelengths. The optical disc device 1000 described herein can perform recording and reproduction on three types of optical discs: BDs, DVDs, and CDs. The optical disc device 1000 is also structured to fit into the size (width 180 mm, height 50 mm) defined by the 1-DIN standard for automotive devices.

Besides the magazine 100 and deck 200, the optical disc device 1000 has a deck swinging mechanism 300 (shown only in FIG. 2) and a substantially rectilinear housing (chassis) 400 that houses the three components 100, 200, 300.

The magazine 100 includes a storage area 110 that stores multiple (e.g., six) optical discs. In the storage area 110, the multiple optical discs are aligned in a direction perpendicular to their information recording surfaces (that is, perpendicular to the surface of the drawing sheet in FIG. 1) so that the positions of their central axes coincide and their information recording surfaces face in the same direction. The front part 410 of the chassis 400 has an aperture (not shown) through which the optical discs are inserted into and ejected from the magazine 100. The magazine 100 has an optical disc transport mechanism 120 for moving an optical disc to insert it into the storage area 110, eject it from the storage area 110, and move it within the storage area 110. A detailed description of the optical disc transport mechanism 120 will be omitted; the optical disc transport mechanism described in Patent Document 1, for example, may be used.

In relation to FIG. 1, the following description assumes, for convenience, that the direction in which the multiple optical discs are arranged in the storage area 110 (i.e., the direction perpendicular to the drawing sheet in FIG. 1) is the vertical direction, and the direction in which the information recording surfaces of the optical discs face within the storage area 110 (the direction into the drawing sheet in FIG. 1) is the down direction. The direction in which the optical discs are inserted and ejected (the left-right direction on the drawing sheet in FIG. 1) is the front-back direction, and the direction in which the optical discs are ejected (the leftward direction in FIG. 1) is the front direction. The direction orthogonal to the vertical direction and front-back direction (the vertical direction on the drawing sheet in FIG. 1) is the left-right direction (the lateral direction), and the rightward direction as seen looking toward the front (the up direction in FIG. 1) is the right direction.

From among the multiple optical discs stored in the storage area 110, the optical disc on which recording or reproduction is to be carried out is selectively loaded into the deck 200, and information is recorded on or reproduced from the loaded optical disc by the deck 200. The deck 200 can swing like a pendulum within a fixed angular range around the deck axis of rotation 260, and is referred to as a floating deck.

The deck swinging mechanism 300 swings the deck 200 around the deck axis of rotation 260, thereby moving the deck 200 between a position (referred to below as the parking position) outside the storage area 110 and a position (referred to below as the loading position) for loading of an optical disc onto the deck 200 within the storage area 110. Thus the deck swinging mechanism 300 moves the deck 200 between the parking position, at which the deck 200 is parked outside the storage area 110, and the loading position, at which the deck 200 is inside the storage area 110. FIG. 1 shows the state in which the deck 200 is located at the parking position with solid lines and the state in which the deck 200 is located at the loading position with two-dot chain lines. A detailed description of the deck swinging mechanism 300 will be omitted; the deck swinging mechanism described in Patent Document 1, for example, may be used.

The deck 200 will now be described in more detail. As shown in FIGS. 1 and 2, the deck 200 includes an optical disc rotating mechanism 210, an optical pickup device 220, a first guide shaft 231, a second guide shaft 232, and a shaft turning mechanism 240, which are disposed on a deck base 250.

The optical disc rotating mechanism 210, onto which an optical disc is loaded for recording or reproduction, spins the optical disc around its axis of rotation (the disc axis of rotation) 211. Specifically, the optical disc rotating mechanism 210 includes a spindle motor 212 having a spindle 212a, and a turntable 213 mounted on the spindle 212a, that rotatably supports the optical disc. The spindle motor 212 spins the spindle 212a, thereby rotationally driving the turntable 213 and spinning the optical disc supported by the turntable 213 around the spindle 212a.

The optical pickup device 220 is a device that moves in the feed direction (also referred to as the traverse direction) parallel to the radial direction of the optical disc rotating around the axis of rotation 211 and records or reproduces information on the information recording surface of the optical disc. Specifically, the optical pickup device 220 has a first objective lens 3 (referred to below as objective lens 3) and a second objective lens 4 (referred to below as objective lens 4). The objective lenses 3, 4 are used for different types of optical discs. Here objective lens 3 is used for BDs and objective lens 4 for DVDs and CDs. The optical components other than the objective lenses 3, 4 of the optical pickup device 220 are covered by a cover 90. The optical pickup device 220 will be described in detail later.

The first guide shaft 231 supports the storage area 110 side of the optical pickup device 220 and guides the movement of the optical pickup device 220 in the feed direction. The second guide shaft 232 supports the side of the optical pickup device 220 opposite the storage area 110 side, and also guides the movement of the optical pickup device 220 in the feed direction. Here and in the following description, the ‘storage area 110 side’ means the side facing the storage area 110 when the deck 200 is located at the parking position.

The lengths of the first and second guide shafts 231, 232 in the feed direction are set such that the objective lenses 3, 4 of the optical pickup device 220 can travel between the innermost and outermost radial positions on the optical disc.

Here, the second guide shaft 232 is a screw shaft provided with a spiral groove for imparting actuating force to the optical pickup device 220. As described later, the optical pickup device 220 has a rack gear 33 that engages the spiral groove on the second guide shaft 232, and is configured so that rotation of the second guide shaft 232 causes the optical pickup device 220 to be driven in the feed direction. The first guide shaft 231 is a shaft with no such groove. In the following description, the first guide shaft 231 will be referred to as the guide shaft 231 and the second guide shaft 232 will be referred to as the screw shaft 232.

The shaft turning mechanism 240 is a mechanism for turning the screw shaft 232. Specifically, the shaft turning mechanism 240 includes a stepping motor 241 for rotationally driving the screw shaft 232. Control of the movement and position of the optical pickup device 220 in the feed direction (i.e., traverse control) is carried out by controlling the rotation of the screw shaft 232 caused by the stepping motor 241. The objective lenses 3, 4 of the optical pickup device 220 are thereby moved at high speed in the space between the innermost radial position and the outermost radial position on the spinning optical disc.

The deck base 250 is a substantially flat plate member shaped to extend in the feed direction of the optical pickup device 220. The guide shaft 231 is placed, extending in the feed direction, at the edge of the deck base 250 on the storage area 110 side. The screw shaft 232 is placed, extending in the feed direction, at the edge of the deck base 250 opposite the storage area 110 side. The optical pickup device 220 is disposed in the space between the guide shaft 231 and screw shaft 232. The turntable 213 is disposed at one end of the deck base 250 in the feed direction of the optical pickup device 220 (i.e., the longitudinal direction of the deck base 250), and the stepping motor 241 and deck axis of rotation 260 are disposed at the other end. In FIG. 1, the turntable 213 is disposed at the end near the aperture where the optical discs are inserted, and the stepping motor 241 and deck axis of rotation 260 are disposed at the opposite end.

As shown in FIG. 1, when the deck 200 is at the parking position, the magazine 100 and deck 200 are side by side in the left-right direction, and the deck 200 is disposed so that the feed direction of the optical pickup device 220 extends in the front-back direction. In order to obtain an adequate storage area 110, or to make the optical disc device 1000 smaller, the edge of deck base 250 on the storage area 110 side has a circular arc shape that arcs around the storage area 110 (or the optical discs). The radius of curvature of the circular arc shape depends on the radius of the optical discs; to match the BD, DVD, and CD radius (60 mm), for example, it is set at about 60 mm.

As shown in FIG. 2, the optical disc device 1000 further includes a controller 500. The controller 500 controls the operation of the magazine 100, deck 200, and deck swinging mechanism 300. The controller 500 is housed, for example, in the chassis 400.

The operation of the optical disc device 1000 will now be described.

On a command from the user, for example, the controller 500 selects an optical disc for recording or reproduction from among the optical discs stored in the storage area 110.

If the selected optical disc is positioned lower than the turntable 213, the controller 500 moves the selected optical disc and all the optical discs stored above it vertically to a position such that the selected optical disc is slightly higher than the turntable 213. The controller 500 also moves all the optical discs stored below the selected optical disc downward in order to secure a space for slotting the deck 200 under the selected optical disc.

Conversely, if the selected optical disc is positioned higher than the turntable 213, the controller 500 moves all the optical discs stored below the selected optical disc downward to secure a space for slotting the deck 200 under the selected optical disc. The controller 500 also moves the selected optical disc and all the optical discs stored above it downward until the selected optical disc is located at a position slightly higher than the turntable 213.

After this movement of the optical discs ends, the controller 500 swings the deck 200 in the direction indicated by arrow A in FIG. 1, thereby moving it from the parking position to the loading position and slotting it into the space under the selected optical disc. Then the controller 500 lowers the selected optical disc to load it onto the turntable 213, and records or reproduces information on the selected optical disc by controlling the deck 200.

After the recording or reproduction of information on the optical disc ends, the controller 500 raises the loaded optical disc and removes it from the turntable 213, then swings the deck 200 in the direction indicated by arrow B in FIG. 1, thereby returning it from the loading position to the parking position. The operation of returning the deck 200 to the parking position is carried out before optical discs are stored or ejected or before another optical disc is loaded; the specific timing may be decided as appropriate. When another optical disc is loaded onto the deck 200 or when optical discs are stored or ejected, it becomes necessary to move the optical discs in the storage area 110; by parking the deck 200 at the parking position, it becomes possible to move the optical discs within the storage area 110 without obstruction by the turntable 213 and optical pickup device 220.

<Optical Pickup Device>

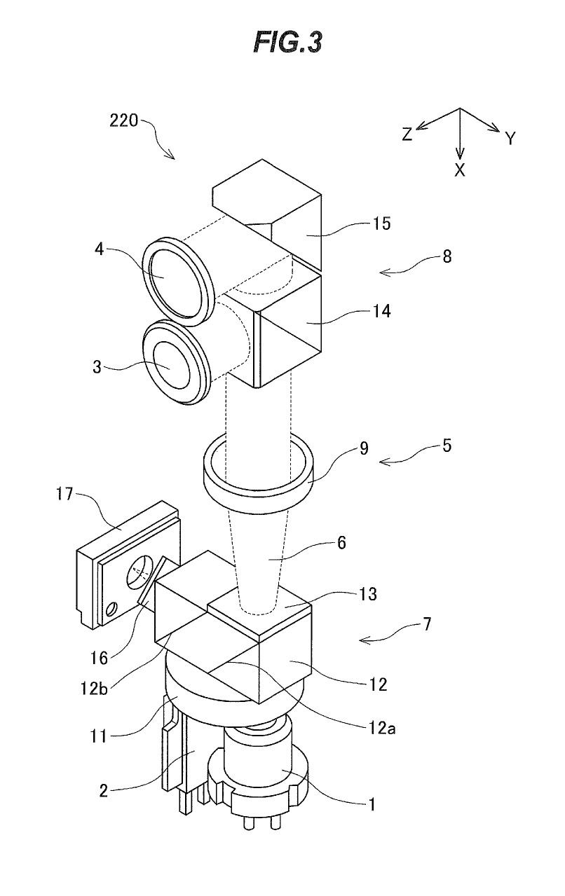

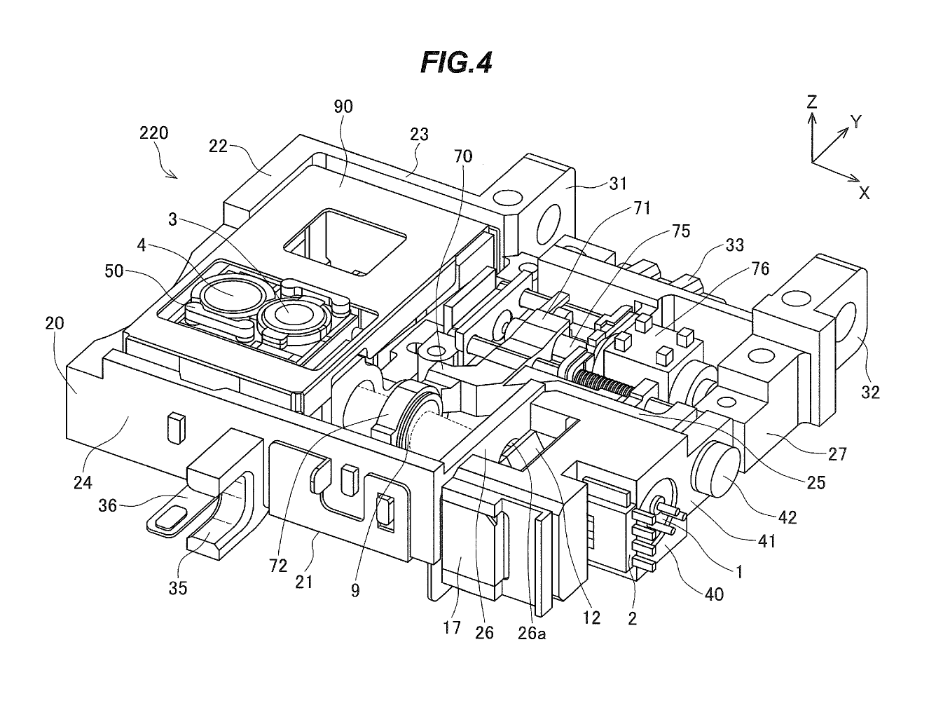

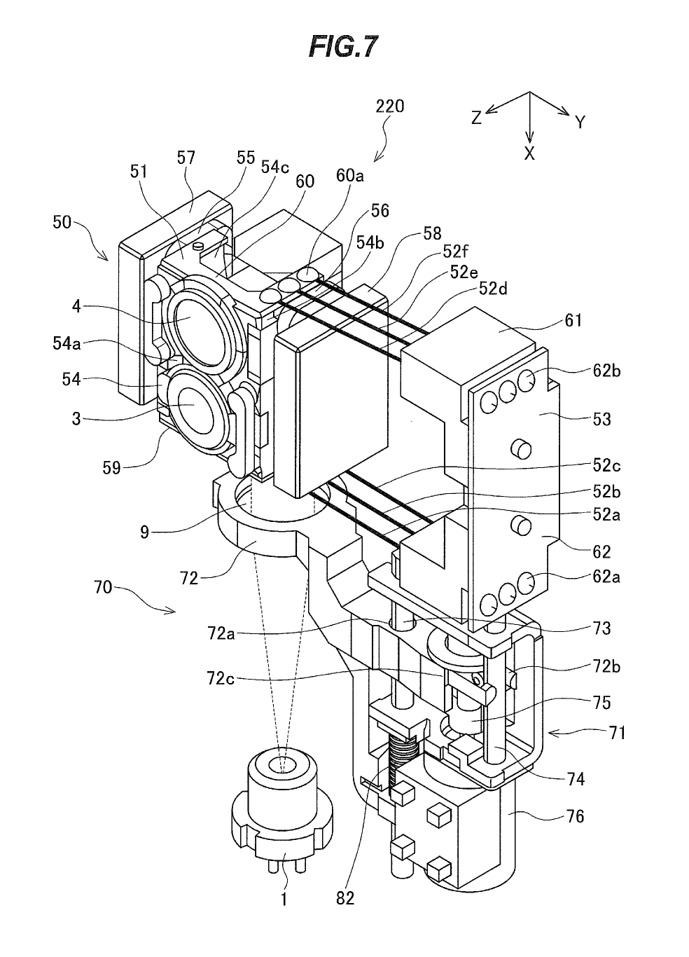

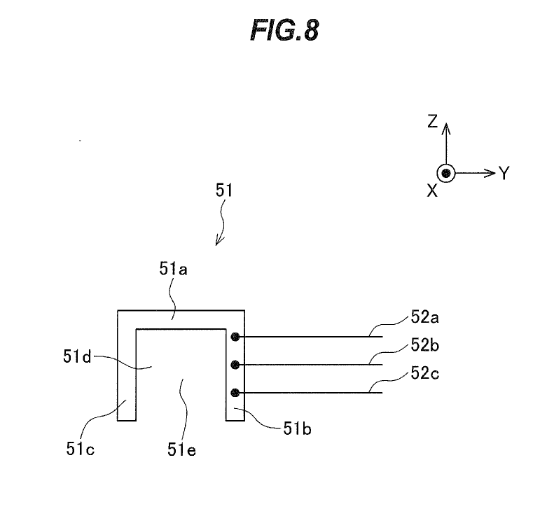

FIG. 3 is a perspective view showing an example of the structure of the optical system of the optical pickup device 220 in the first embodiment. FIGS. 4, 5, and 6 are, respectively, a perspective view, a top view, and a rear view showing an example of the structure of the optical pickup device 220 in the first embodiment. FIG. 7 is a perspective view showing an example of the structure of the objective lens actuator 50 and spherical aberration correction apparatus 70 of the optical pickup device 220 in the first embodiment. FIG. 8 is a schematic drawing showing the structure of the movable part 51 of the objective lens actuator 50 when seen from the direction of the spherical aberration correction lens 9. The structure of the optical pickup device 220 in the first embodiment will now be described with reference to FIGS. 3 to 8.

The following description of the optical pickup device 220 will assume, for convenience, that the feed direction of the optical pickup device 220 (i.e., the radial direction on the optical disc) is the X direction (or the front-back direction); the direction toward the outer circumference of an optical disc is the +X (backward) direction; the direction toward the inner circumference of the optical disc is the −X (forward) direction. It will also be assumed that the direction of the axis of rotation 211 of the optical disc (i.e., the direction perpendicular to the information recording surface of the optical disc) is the Z direction (the vertical direction); the direction from the optical pickup device 220 to the optical disc is the +Z (upward) direction; the opposite direction is the −Z (downward) direction. The direction orthogonal to both the X and Z directions is the Y direction (the left-right direction); the direction from the optical pickup device 220 to the storage area 110 side is the −Y (leftward) direction; the opposite direction is +Y (rightward) direction. The +X direction, +Y direction, and +Z direction are indicated by arrows in FIGS. 3 to 8.

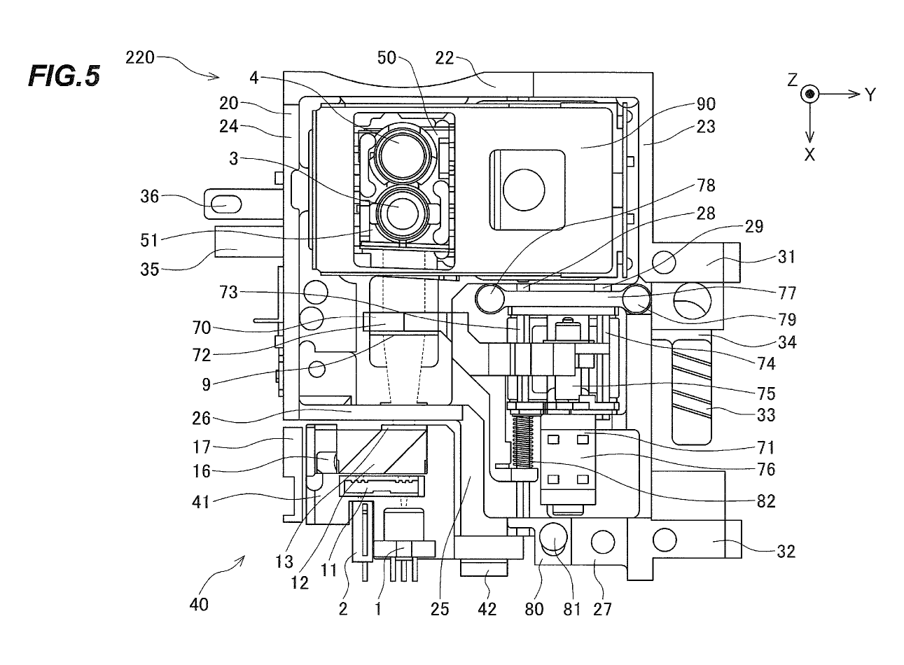

Portions of the cover 90 are omitted in FIGS. 4 and 5 in order to show the internal structure of the optical pickup device 220. The optical pickup device 220 is connected to a flexible printed circuit board, not shown in the drawings, to receive externally supplied control signals and power (from, for example, the controller 500). The dashed lines in FIGS. 3 to 5 and FIG. 7 indicate laser beams.

<Optical System of the Optical Pickup Device>

First the optical system of the optical pickup device 220 will be described, mainly with reference to FIG. 3. Besides the objective lenses 3, 4, the optical pickup device 220 has a first light source 1 (simply ‘light source 1’ below) and a second light source 2 (simply ‘light source 2’ below).

Light source 1 emits light with a first wavelength. Here, light source 1 is a BD light source for recording and reproduction on BDs, and emits light for BDs. Specifically, light source 1 is a semiconductor laser emitting blue-violet laser light with a wavelength of 405 nm. A semiconductor laser in a cylindrical package is used as light source 1 here; in order to reduce the size of the optical system, a cylindrical package with a small diameter is used.

Light source 2 emits light with a second wavelength differing from the first wavelength. Light source 2 must emit at least the second wavelength, but may emit light with two or more wavelengths including the second wavelength. Here, light source 2 is a light source for recording and reproduction on DVDs and CDs, and selectively emits light for DVDs and light for CDs. Specifically, light source 2 is a two-wavelength semiconductor laser that emits red laser light with a wavelength of 680 nm (light with the second wavelength) for DVDs and infrared laser light with a wavelength of 780 nm (light with a third wavelength) for CDs. Light source 2 is a two-wavelength semiconductor laser in a flat package having a thin shape. In this example, a flat package is used for light source 2 because using a cylindrical package for light source 2 would make the dimensions of the optical pickup device larger than a given size. From the viewpoint of reducing the size of the optical system, light source 2 is disposed in such a way that when seen from the feed direction (the X direction), it has a substantially rectangular shape, its narrow width (short sides) being oriented parallel to the information recording surface of the optical disc, its wide width (long sides) being perpendicular to the information recording surface of the optical disc.

Objective lens 3 focuses light from light source 1 onto the information recording surface of the optical disc. Specifically, objective lens 3 is an objective lens for BDs that focuses light for BDs from light source 1 onto the information recording surface of the BDs.

Objective lens 4 focuses light from light source 2 onto the information recording surface of the optical disc. Specifically, objective lens 4 is an objective lens for DVDs and CDs that focuses light for DVDs and CDs from light source 2 onto the information recording surfaces of DVDs and CDs, respectively.

From the viewpoint of reducing the width of the optical pickup device 220 in the Y direction, the light sources and objective lenses are disposed as follows. When viewed from the axis of rotation 211 of the optical disc (referred to below as the disc axis direction), the objective lenses 3, 4 and light source 1 are all aligned on a straight line LX passing through the axis of rotation 211 (or the center of the spindle 212a) and parallel to the feed direction, as shown in FIGS. 1 and 3. More specifically, the centers of the two objective lenses 3, 4 and light source 1 are aligned on the straight line LX. As shown in FIG. 3, light source 2 is disposed adjacent light source 1 in the Y direction. That is, light source 2 is disposed beside light source 1. Light source 2 is disposed in such a way that light emitted from light source 2 travels parallel to the direction of light emitted from light source 1. The light sources are disposed in such a way that the axis of the beam emitted from light source 1 is on the straight line LX when seen from the disc axis direction, and the axis of the beam emitted from light source 2 is parallel to the axis of the beam emitted from light source 1.

The optical pickup device 220 has an optical system 5 for guiding light from light source 1 to objective lens 3 and light from light source 2 to objective lens 4. Specifically, the optical system 5 includes a combiner 7 for combining light from light source 1 and light from light source 2 onto a shared optical path 6 in the feed direction (X direction) and a splitter 8 for splitting the light from the shared optical path 6 into a beam traveling from light source 1 to objective lens 3 and a beam traveling from light source 2 to objective lens 4. The optical system 5 includes a spherical aberration correction lens 9, disposed on the shared optical path 6, for correcting spherical aberration. When seen from the disc axis direction, the spherical aberration correction lens 9 is disposed on the straight line connecting light source 1 and objective lens 3. That is, when seen from the disc axis direction, the objective lenses 3, 4, the spherical aberration correction lens 9, and light source 1 are lined up in a row on the straight line LX.

In the example in FIG. 3, the combiner 7 is configured as a combining prism 12 having two reflecting surfaces 12a, 12b.

The splitter 8 includes specifically of a first folding mirror 14, which is a wavelength selection mirror for reflecting light from one of the light sources 1, 2 toward the corresponding one of the objective lenses 3, 4 and transmitting light from the other light source, and a second folding mirror 15 for reflecting the light from the other light source that has passed through the first folding mirror 14 toward the corresponding other one of the objective lenses 3, 4. When the objective lenses 3, 4 are disposed in the order shown in FIG. 3, the first folding mirror 14 reflects light from light source 1 toward objective lens 3 and transmits light from light source 2, and the second folding mirror 15 reflects light transmitted through the first folding mirror 14 toward objective lens 4. In the example in FIG. 3, a dichroic prism is used as the first folding mirror 14, and a triangular mirror is used as the second folding mirror 15. In the following description, the folding mirrors 14, 15 will be respectively referred to as the dichroic prism 14 and the triangular mirror 15.

More specifically, the structure and operation of the BD optical system of the optical pickup device 220 are as follows. The BD optical system consists of light source 1, a diffraction grating 11, the combining prism 12, a waveplate 13, the spherical aberration correction lens 9, the dichroic prism 14, objective lens 3, a cylindrical lens 16, and a photodetector 17.

Light source 1 is disposed so as to emit light in the −X direction (feed direction); the diffraction grating 11, combining prism 12, waveplate 13, spherical aberration correction lens 9, and dichroic prism 14 are aligned, in this order in the direction of propagation of light from light source 1, on a straight line extending in the X direction. The dichroic prism 14 is disposed just below objective lens 3 (in the −Z direction). The combining prism 12 is disposed in such a way that light from light source 1 is incident on reflecting surface 12a. The cylindrical lens 16 and photodetector 17 are disposed in this order in the −Y direction from the combining prism 12.

The BD laser light emitted from light source 1 enters the diffraction grating 11. The diffraction grating 11 diffracts the incident laser light, producing a main beam of O-order light and two sub beams of ±1-order light. One main beam and two sub-beams are thereby focused onto the optical disc. The laser light output from the diffraction grating 11 passes through reflecting surface 12a in the combining prism 12 and strikes the waveplate 13. The waveplate 13 converts the incident linearly polarized laser light to circularly polarized laser light. The laser light (a divergent beam) exiting the waveplate 13 enters the spherical aberration correction lens 9. The spherical aberration correction lens 9 is configured as a collimator lens that converts the incoming laser beam to a collimated beam. The laser light (a collimated beam) exiting the spherical aberration correction lens 9 enters the dichroic prism 14. The dichroic prism 14 folds the direction of propagation of the incoming laser beam at a right angle, redirecting it in the +Z direction. The folded laser beam from the dichroic prism 14 enters objective lens 3. Objective lens 3 focuses the incident BD laser light onto the information recording surface of the BD.

The returning light reflected by the information recording surface of the BD enters the combining prism 12 via objective lens 3, the dichroic prism 14, the spherical aberration correction lens 9, and the waveplate 13 and is folded at a right angle and thereby redirected in the −Y direction by reflecting surface 12a in the combining prism 12; the folded beam then enters the photodetector 17 via the cylindrical lens 16. The photodetector 17 converts the received light to an electrical signal, which it outputs. The output signal is processed by the controller 500, for example, to generate a reproduced signal, a focus error signal, a tracking error signal, etc.

The structure and operation of the DVD and CD optical system of the optical pickup device 220 are as follows. The DVD and CD optical system consists of light source 2, the diffraction grating 11, the combining prism 12, the waveplate 13, the spherical aberration correction lens 9, the dichroic prism 14, the triangular mirror 15, objective lens 4, the cylindrical lens 16, and the photodetector 17. Accordingly, the spherical aberration correction lens 9, diffraction grating 11, combining prism 12, waveplate 13, dichroic prism 14, cylindrical lens 16, and photodetector 17 are optical components used in common for BDs, DVDs, and CDs.

Light source 2 is disposed in such a way that the direction of its emitted light is identical to the direction (−X direction) of light emitted by light source 1, and the height of the light emitting position (i.e., the position in the Z direction) of the light is the same as the height of the light emitting position of light source 1. The diffraction grating 11 is disposed in such a way that it also receives the light from light source 2. The combining prism 12 is disposed in such a way that the light from light source 2 is incident on reflecting surface 12b. The triangular mirror 15 is disposed in the −X direction from dichroic prism 14 and just below objective lens 4 (in the −Z direction).

DVD laser light emitted from light source 2 strikes the diffraction grating 11. The diffraction grating 11 diffracts the incident laser light, producing a main beam of O-order light and two sub beams of ±1-order light. One main beam and two sub-beams are thereby focused onto the optical disc. The laser light output from diffraction grating 11 is folded at a right angle and redirected in the +Y direction by reflecting surface 12b in the combining prism 12 and then folded at a right angle and redirected in the −X direction by reflecting surface 12a. That is, the combining prism 12 makes the light path of the DVD laser light from light source 2 coincide with the light path of the BD laser light from light source 1. The laser light exiting the combining prism 12 strikes the waveplate 13. The waveplate 13 converts the incident linearly polarized laser light to circularly polarized laser light. The laser light (a divergent beam) exiting the waveplate 13 enters the spherical aberration correction lens 9. The spherical aberration correction lens 9 converts the incident laser light to a collimated beam. The laser light (a collimated beam) exiting the spherical aberration correction lens 9 passes straight through the dichroic prism 14 and strikes the triangular mirror 15. The triangular mirror 15 folds the direction of propagation of the incident laser beam at a right angle, redirecting it in the +Z direction. The folded laser beam from the triangular mirror 15 enters objective lens 4. Objective lens 4 focuses the incident DVD laser light onto the information recording surface of the DVD.

The returning light reflected by the information recording surface of the DVD enters the combining prism 12 via the triangular mirror 15, the dichroic prism 14, the spherical aberration correction lens 9, and the waveplate 13 and is folded at a right angle and thereby redirected in the −Y direction by reflecting surface 12a in the combining prism 12; the folded beam then enters the photodetector 17 via the cylindrical lens 16. The photodetector 17 converts the received light to an electrical signal, which it outputs. The output signal is processed by the controller 500, for example, to generate a reproduced signal, a focus error signal, a tracking error signal, etc.

CD laser light emitted from light source 2 is focused on the information recording surface of a CD by objective lens 4, and the light reflected and returned by the information recording surface of the CD is converted to an electrical signal by the photodetector 17 and processed in the same way as DVD laser light.

<Specific Structure of the Optical Pickup Device>

The specific structure of the optical pickup device 220 will be described below mainly with reference to FIGS. 4 to 6.

As shown in FIGS. 4 to 6, the optical pickup device 220 has a base 20 constituting its floor and walls, a light source unit 40, an objective lens actuator 50, and a spherical aberration correction apparatus 70. The light source unit 40, objective lens actuator 50, and spherical aberration correction apparatus 70 are mounted on the base 20.

The base 20 has a bottom part 21 with a substantially flat plate shape facing the information recording surface of the optical disc, and a front part 22, a right side part 23, left side parts 24, 25, and rear parts 26 and 27 rising from respective edges of the bottom part 21. The front part 22 is located at the front edge of the bottom part 21, and extends in the left-right direction. The right side part 23 is located at the right edge of the bottom part 21, and extends backward from the right end of the front part 22. Left side part 24 is located at the left edge of the bottom part 21, and extends backward from the left end of the front part 22. The length of left side part 24 in the front-back direction is shorter than the length of the right side part 23 in the front-back direction, being about two thirds of the length of the right side part 23 in the front-back direction. Rear part 26 is located at the rear edge of the bottom part 21, extending in the rightward direction from the rear end of left side part 24. The length of rear part 26 in the left-right direction is shorter than the length of the front part 22 in the left-right direction, being about one half the length of the front part 22 in the left-right direction. Left side part 25 is located at the left edge of the bottom part 21, extending backward from the right end of rear part 26. The length of left side part 25 in the front-back direction corresponds to the difference in length between the right side part 23 and left side part 24 in the front-back direction, being about one-third of the length of the right side part 23 in the front-back direction. Rear part 27 is located at the rear edge of the bottom part 21, extending in the rightward direction from the rear end of left side part 25 to the rear end of the right side part 23. The length of rear part 27 in the left-right direction corresponds to the difference in length between the front part 22 and rear side part 26 in the left-right direction, being about one half the length of the front part 22 in the left-right direction.

Screw shaft bearings 31, 32 and the rack gear 33 are disposed on the right side part 23 of the base 20. The screw shaft 232 is slidably inserted through the screw shaft bearings 31, 32. The rack gear 33 is attached to the right side part 23 by a spring 34 that presses the rack gear 33 against the screw shaft 232 so that it engages the spiral groove of the screw shaft 232. Rotation of the screw shaft 232 drives the rack gear 33 in the front-back direction, moving the optical pickup device 220 in the feed direction. Control of the rotation of the screw shaft 232 by the stepping motor 241 accordingly controls the movement and position of the optical pickup device 220 in the feed direction.

A guide shaft bearing 35 and a bias spring 36 are disposed on left side part 24 of the base 20. The guide shaft 231 is slidably inserted thorough the guide shaft bearing 35. The bias spring 36 maintains a constant pressure on the guide shaft 231, thereby stabilizing the traverse control of the optical pickup device 220.

The light source unit 40 has a light source unit holder 41, to which the light sources 1 and 2, combining prism 12, waveplate 13, cylindrical lens 16, and photodetector 17 are secured. The diffraction grating 11 is secured to a diffraction grating holder (not shown) that is rotatably attached to the light source unit holder 41, and is positioned by a spring plate (not shown). The light source unit holder 41 is secured to the base 20 with a screw 42 in an orientation such that the light sources 1 and 2 emit light in the −X direction. The light source unit 40 is disposed adjoining the outer surfaces of rear side part 26 and left side part 25; the base 20 on which the light source unit 40 is mounted has a substantially rectangular shape when seen from the Z direction. A hole 26a is formed in the part of rear side part 26 facing the waveplate 13, extending clear through rear side part 26 in the X direction; light from the light source unit 40 passes through the hole 26a and emerges on the side above the base 20; light entering from that side passes through the hole 26a into the light source unit 40.

The objective lens actuator 50 holds and actuates the objective lenses 3, 4. Specifically, the objective lenses 3, 4 are mounted on the objective lens actuator 50, aligned in the radial direction (X direction) of the optical disc. The objective lens actuator 50 actuates the objective lenses 3, 4 in three axial directions: the focus direction, tracking direction, and tilt direction. The focus direction (Z direction) is parallel to the disc axis direction. The tracking direction (X direction) is parallel to the radial direction of the optical disc. The tilt direction is a direction of rotation about a tangential axis orthogonal to the focus direction and tracking direction. Actuation of the objective lenses 3, 4 in the focus direction, tracking direction, and tilt direction is controlled to carry out focus control, tracking control, and tilt control of the objective lenses 3, 4.

The objective lens actuator 50 is disposed on the base 20 so as to occupy an area on the −X side of the base 20, as shown in FIGS. 4 and 5. The dichroic prism 14 is placed under the objective lens actuator 50, directly below objective lens 3 (in the −Z direction); the triangular mirror 15 is disposed directly below objective lens 4 (in the −Z direction). The dichroic prism 14 and triangular mirror 15 are secured to the base 20.

The spherical aberration correction apparatus 70 is a device for correcting spherical aberration of laser light incident on the optical disc from the objective lenses 3, 4; the spherical aberration correction apparatus 70 includes the spherical aberration correction lens 9 and has a linear actuator 71 for actuating the spherical aberration correction lens 9. The linear actuator 71 holds the spherical aberration correction lens 9 and displaces it in its optical axis direction (X direction). Control of the displacement of the spherical aberration correction lens 9 in the optical axis direction by the linear actuator 71 controls the position of the spherical aberration correction lens 9 in its optical axis direction and corrects spherical aberration. Specifically, the displacement of the spherical aberration correction lens 9 by the linear actuator 71 is controlled to produce the best focused light spot on the optical disc. The spherical aberration correction lens 9 is a three-wavelength lens compatible with the BD wavelength, DVD wavelength, and CD wavelength, and the position of the spherical aberration correction lens 9 in the optical axis direction is controlled to be optimal for the type of the optical disc, BD, DVD, or CD, on which recording or reproduction is carried out.

The spherical aberration correction apparatus 70 is disposed on the base 20 so as to occupy an area on the +X side of the objective lens actuator 50 on the base 20.

The objective lens actuator 50 and spherical aberration correction apparatus 70 will now be described, mainly with reference to FIG. 7.

The objective lens actuator 50 includes a movable part 51 for holding the objective lenses 3, 4, a plurality of wires (six, in this example) 52a to 52f, each of which is secured at one end to the movable part 51, and a support 53 to which the other ends of the wires 52a to 52f are secured; the support 53 displaceably supports the movable part 51 through the plurality of wires 52a to 52f. The movable part 51 and support 53 are aligned in the Y direction so that the wires 52a to 52f extend in the Y direction. The movable part 51 is movably mounted on the base 20; the support 53 is immovably mounted to the base 20. Specifically, the movable part 51 is disposed on the guide shaft 231 side (the −Y side) of the objective lens actuator 50 and the support 53 is disposed on the screw shaft 232 side (the +Y side). That is, the movable part 51 is disposed in the direction of forward swing of the deck 200 and the support 53 is disposed in the direction of backward swing.

As shown in FIG. 8, the movable part 51 has an upper part 51a facing the information recording surface of the optical disc, a first side part 51b extending in the −Z direction from the end of the upper part 51a on the support 53 side, and a second side part 51c extending in the −Z direction from the end of the upper part 51a on the side opposite the support 53 side. The objective lenses 3, 4 are mounted on the upper part 51a. One end of each of the wires 52a to 52f is secured to first side part 51b. Specifically, of the six wires, three wires 52a to 52c are secured to the +X-directional end of the first side part 51b in a row extending in the Z direction, and the other three wires 52d to 52f (not shown in FIG. 8) are secured to the −X-directional end of the first side part 51b in a row extending in the Z direction.

The upper part 51a, first side part 51b, and second side part 51c collectively bound a space 51e extending in the feed direction (X direction) with an opening 50d facing toward light source 1 (in the +X direction). The space 51e constitutes a light path that receives light exiting the spherical aberration correction lens 9 in the −X direction through the opening 51d and takes the light to the objective lenses 3, 4. Specifically, the dichroic prism 14 and triangular mirror 15 are disposed within the space 51e; light exiting the spherical aberration correction lens 9 passes through the opening 51d, is reflected by the dichroic prism 14 or triangular mirror 15, and then enters objective lens 3 or 4.

As shown in FIG. 7, specifically, the movable part 51 has a lens holder 54 for holding the objective lenses 3, 4. The lens holder 54 has an upper part 54a facing the information recording surface of the optical disc, a right side part 54b extending in the −Z direction from the end of the upper part 54a facing the support 53, and a left side part 54c extending in the −Z direction from the other end of upper part 54a, distant from the support 53. The cross-sectional shape of the lens holder 54 when cut in a plane perpendicular to the X direction is substantially a U-shape open in the −Z direction throughout its length in the X direction. The objective lenses 3, 4 are disposed on the upper part 54a of the movable part 51.

The objective lens actuator 50 actuates the objective lenses 3, 4 by electromagnetic forces produced by coils and magnets; a focus control coil, a tracking control coil, and a tilt control coil are mounted on the right side part 54b and left side part 54c of the lens holder 54. The magnets are immovably mounted on the base 20 at positions facing these coils. FIG. 7 shows typical exemplary coils 55 and 56 and magnets 57 and 58. Boards 59 and 60 for supplying power to the individual coils are attached to the two X-directional end faces of the lens holder 54. The shapes of the boards 59 and 60 are substantially the same as the shape of the lens holder 54 seen from the X direction, substantially a U-shape open in the −Z direction.

The support 53 has a suspension holder 61 secured to the base 20 and a board 62 attached to the suspension holder 61 to supply power to the coils in the movable part 51.

The wires (also referred to as the suspension wires) 52a to 52f function as elastic supporting members for elastically supporting the movable part 51, and also as power supply lines for supplying electric current to the coils in the movable part 51. The ends of wires 52a to 52c on the movable part 51 side are bonded to the +X-side board 59 by three solder bonds (not shown); the ends of wires 52d to 52f on the movable part 51 side are bonded by three solder bonds 60a to the −X-side board 60. The three solder bonds on the board 59 are aligned in a row extending in the Z direction on the part of the board 59 near the support 53; the three solder bonds 60a on the board 60 are aligned in a row extending in the Z direction on the part of the board 60 near the support 53. The wires 52a to 52f extend from the movable part 51 to the support 53 in the Y direction. The ends of wires 52a to 52c on the support 53 side are bonded to the +X-directional edge of the board 62 by three solder bonds 62a; the ends of wires 52d to 52f on the support 53 side are bonded to the −X-side edge of the board 62 by three solder bonds 62b. Electric current is thereby supplied from the board 62 on the support 53 to the coils in the movable part 51 through the wires 52a to 52f and boards 59, 60. Three-axis control, i.e., focus control, tracking control, and tilt control, are carried out by controlling the current flowing to the individual coils of the movable part 51, thereby controlling the electromagnetic forces generated between the coils and magnets. The astigmatic method, for example, can be used as the focus control method; the DDP (Differential Push Pull) method or DPD (Differential Phase Detection) method, for example, can be used as the tracking control method.

Focus control, tracking control, tilt control and the electromagnetic objective lens actuator configuration are widely known, so descriptions will be omitted here.

The spherical aberration correction apparatus 70 includes the spherical aberration correction lens 9 and the linear actuator 71 that actuates the spherical aberration correction lens 9. The linear actuator 71 includes a lens holder 72, a main guide shaft 73, a sub guide shaft 74, an actuating screw 75, and a stepping motor 76.

The lens holder 72 is a holding member that holds the spherical aberration correction lens 9 and enables it to move in the X direction. The lens holder 72 has a shape that extends in the Y direction; the spherical aberration correction lens 9 is held by the −Y end portion of the lens holder 72. The +Y end portion of the lens holder 72 is provided with a precision bearing 72a through which the main guide shaft 73 passes, a bearing 72b through which the sub guide shaft 74 passes, and a bearing 72c through which the actuating screw 75 passes.

The main guide shaft 73 and sub guide shaft 74 are guide members that guide the X-directional movement of the lens holder 72. The main guide shaft 73 and sub guide shaft 74 are set in the base 20 such that the axis of each shaft extends in the X direction. The main guide shaft 73 and sub guide shaft 74 are spaced apart from each other in the base 20 by a predetermined distance, the main guide shaft 73 being located in the −Y direction and the sub guide shaft 74 in the +Y direction. Specifically, as shown in FIG. 5, the base 20 is provided with a groove 28 extending in the X direction for the main guide shaft, and a groove 29 extending in the X direction for the sub guide shaft. The main guide shaft 73 and sub guide shaft 74 are inserted in the grooves 28 and 29, respectively. The main guide shaft 73 and sub guide shaft 74 are secured to the base 20 by a spring plate 77, screws 78 and 79, a spring plate 80, and a screw 81. To ensure that the load of the spring plates is applied to the guide shafts 73 and 74, the depth of the groove 28 for the main guide shaft is set at a value slightly less than the diameter of the main guide shaft 73, and the depth of the groove 29 for the sub guide shaft is set at a value slightly less than the diameter of the sub guide shaft 74. In order to improve the straightness accuracy of the movement of the spherical aberration correction lens 9, the Y-directional width of the groove 28 for the main guide shaft is set at a dimension substantially identical to the diameter of the main guide shaft 73. The Y-directional width of the groove 29 for the sub guide shaft is set at a dimension greater than the diameter of the sub guide shaft 74.

In FIG. 7, the actuating screw 75 is a shaft-like member in which a spiral groove is formed for actuating the lens holder 72. The actuating screw 75 is inserted into the bearing 72c of the lens holder 72 with its axis extending in the X direction. A groove that engages the groove of the actuating screw 75 is formed in the bearing 72c, so that rotation of the actuating screw 75 causes the lens holder 72 to move in the X direction. In the Y direction, the actuating screw 75 is disposed between the main guide shaft 73 and sub guide shaft 74.

The stepping motor 76 is the prime mover for actuating the spherical aberration correction lens 9. Specifically, the +X-directional end portion of the actuating screw 75 is connected to the output shaft of the stepping motor 76. The stepping motor 76 rotates the actuating screw 75, thereby moving the lens holder 72 and the spherical aberration correction lens 9 in the X direction. Spherical aberration is corrected by controlling the rotation of the shaft of the stepping motor 76, thereby controlling the position of the spherical aberration correction lens 9 in the X direction. Methods of correcting spherical aberration by controlling the position of a collimator lens are well known, so a description will be omitted here.

In order to enable smooth movement of the spherical aberration correction lens 9 without play while maintaining high straightness accuracy, the lens holder 72 is biased in the axial direction and rotational direction of the guide shafts 73, 74 by a coil spring 82.

In the interest of reducing the space occupied by the light (collimated light beam) output from the spherical aberration correction lens 9, the spherical aberration correction apparatus 70 is configured so that the spherical aberration correction lens 9 is located near the movable part 51 of the objective lens actuator 50 (on its +X side).

Since there are no optical elements concerned with the laser beam path near the support 53 in the objective lens actuator 50 (on its +X side), most of the components of the linear actuator 71, namely the main guide shaft 73, sub guide shaft 74, actuating screw 75, and stepping motor 76, are disposed near the support 53 in the objective lens actuator 50 (on its +X side).

The traverse control, focus control, tracking control, tilt control, and spherical aberration correction control mentioned above are carried out by, for example, the controller 500.

<Dimensions of the Optical Pickup Device>

The dimensions of the optical pickup device 220 with the above configuration will be described below.

As shown in FIG. 5, the Y-directional width of the main body of the optical pickup device 220, excluding the screw shaft bearings 31, 32 and the guide shaft bearing 35, (that is, the Y-directional width from the outer surface of the right side part 23 to the outer surface of left side part 24) is substantially equal to the Y-directional width of the objective lens actuator 50.

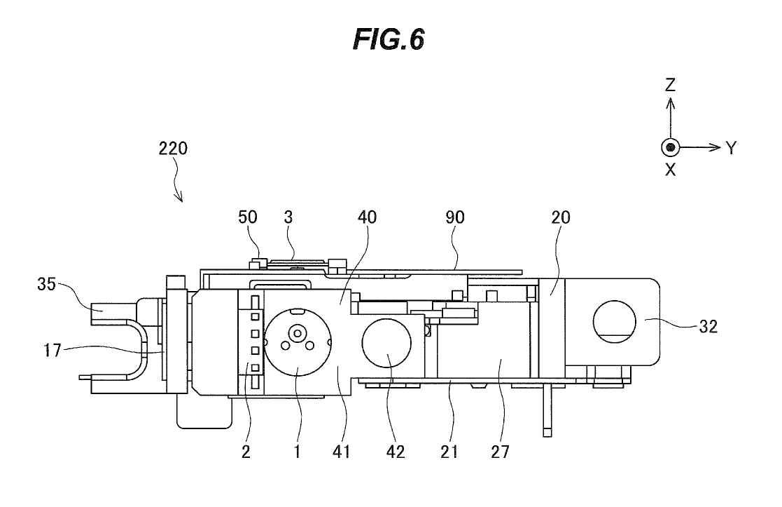

As shown in FIG. 6, the Z-directional height of the main body of the optical pickup device 220 (i.e., the Z-directional height from the lower surface of the bottom part 21 to the upper surface of the objective lenses 3, 4) is substantially equal to the Z-directional height of the objective lens actuator 50.

As shown in FIG. 5, when seen from the disc axis direction (Z direction), the objective lenses 3, 4 are disposed at positions nearer to the guide shaft 231 (or the guide shaft bearing 35) than to the screw shaft 232 (or the screw shaft bearings 31, 32). That is, the Y-directional distance from the line LX on which the objective lenses 3, 4 are aligned to the guide shaft 231, in the direction in which the deck swings forward, is shorter than the Y-directional distance from line LX to the screw shaft 232, in the direction in which the deck swings backward. In the example in FIG. 5, when seen from the Z direction, the Y-directional distance from the center of objective lens 3 to the −Y-side outer surface of the main body of the optical pickup device 220 (i.e., the outer surface of left side part 24 or the right end of the guide shaft bearing 35) is about half the Y-directional distance from the center of objective lens 3 to the +Y-side outer surface of the main body of the optical pickup device 220 (i.e., the outer surface of the right side part 23 or the left ends of the screw shaft bearings 31, 32). In one specific exemplary configuration, when seen from the Z direction, the Y-directional distance from the center of objective lens 3 to the −Y-side outer surface of the main body of the optical pickup device 220 is approximately 10 mm, and the Y-directional distance from the center of objective lens 3 to the +Y-side outer surface of the main body of the optical pickup device 220 is about 20 mm. That is, the Y-directional width of the main body of the optical pickup device 220 is about 30 mm.

The following effects (1) to (9) can be obtained from the first embodiment described above.

(1) When seen from the disc axis direction, the first and second objective lenses and the first light source are aligned on a line passing through the rotational axis of the optical disc and parallel to the feed direction. The size of the optical pickup device in the direction orthogonal to both the disc axis direction and the feed direction can thereby be reduced. Specifically, the optical system of the optical pickup device can be formed along the line parallel to the feed direction, which can reduce the size of the optical pickup device in the direction (Y direction) orthogonal to both the disc axis direction and feed direction. The offset (called the ‘off-center’) between the objective lenses and the line passing through the center of the rotational axis of the optical disc and parallel to the feed direction can be reduced (e.g., to zero or substantially zero), which facilitates control of the optical pickup device (e.g., tracking control).

By using the above configuration to reduce the size of the optical pickup device, it is possible to produce a 1-DIN-size optical disc device of the deck swinging changer type that is usable with three types of optical discs (BD/DVD/CD).

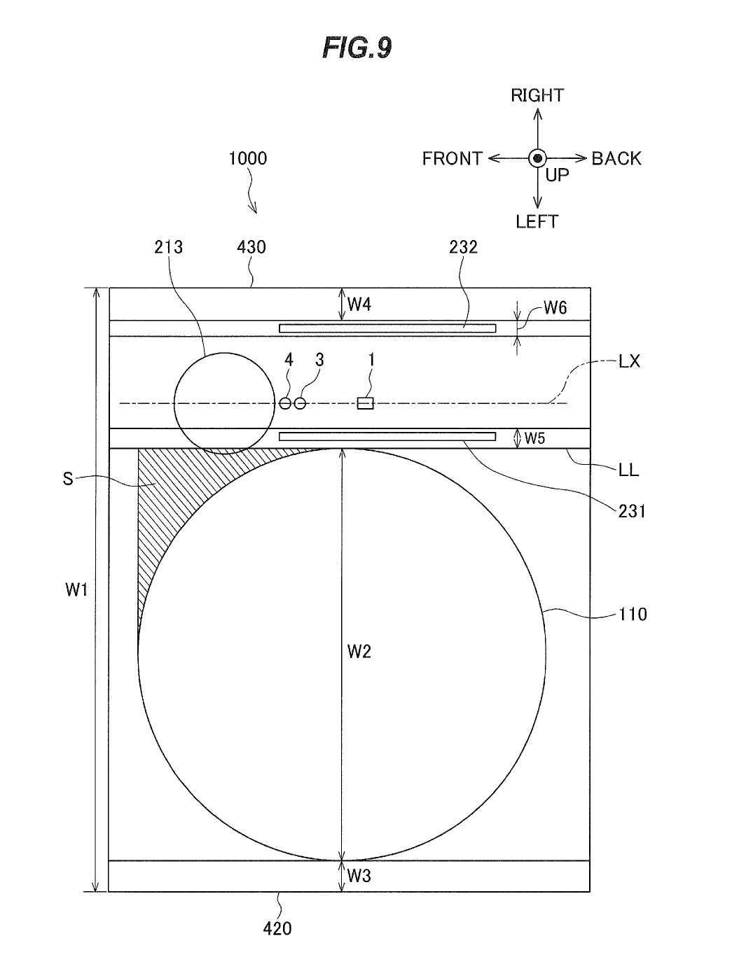

FIG. 9 is a schematic top view of the optical disc device 1000 that will be used to describe its dimensions.

In FIG. 9, in order to bring the size of the optical disc device 1000 within the 1-DIN standard (lateral width 180 mm, height 50 mm), the lateral width W1 (i.e., the width in the direction in which the magazine 100 and deck 200 are aligned) of the chassis 400 needs to be limited to a value equal to or less than 180 mm.

The diameters of BD, DVD, and CD optical discs are all 120 mm. Accordingly, the lateral width W2 of the storage area 110 at the front-back directional position at which the lateral width of the storage area 110 is maximum is 120 mm.

Since the optical disc transport mechanism 120 and other components are disposed between the left side part 420 of the chassis 400 and the storage area 110, the width W3 of the space between the left side part 420 and the storage area 110 is set at about 10 mm. Since the deck swinging mechanism 300 and other components are disposed between the right side part 430 of the chassis 400 and the deck 200, the width W4 of the space between the right side part 430 and the deck 200 is set at about 10 mm.

Accordingly, the allowable lateral width of the deck 200 is minimal at the front-back directional position where the storage area 110 has the greatest lateral width, and the deck 200 must be configured in such a way that its lateral width at this front-back directional position is 40 mm or less. The optical pickup device 220 mounted on the deck 200 must therefore be configured according to the minimum lateral width allowed for the deck 200.

Specifically, the guide shaft 231 and guide shaft bearing 35 are disposed at the left edge of the deck 200 and the screw shaft 232 and screw shaft bearings 31, 32 are disposed at the right edge of the deck 200. The sum of the width W5 of the space between the left end of the deck 200 and the left edge of the main body of the optical pickup device 220 and the width W6 of the space between the right edge of the deck 200 and the right edge of the main body of the optical pickup device 220 is about 10 mm.

Accordingly, in order to be mounted on the deck 200, the optical pickup device 220 must be configured in such a way that the lateral width of its main body is about 30 mm or less.

This embodiment makes it possible to configure a optical pickup device 220 having a main body with a lateral width of 30 mm or less, that is, a optical pickup device 220 small enough to be mountable in the deck 200 of a 1-DIN-size optical disc device of the deck swinging changer type usable with three types of optical discs (BD/DVD/CD).

The configuration described in Patent Document 2, when seen from the disc axis direction, disposes two objective lenses and a DVD light source on a line perpendicular to the feed direction. Accordingly, the configuration described in Patent Document 2 increases the dimension in the direction perpendicular to the feed direction, making it impossible to configure an optical pickup device mountable in the deck of the 1-DIN-size optical disc device.

(2) The optical system of the optical pickup device includes a combiner for merging light from the first and second light sources into a shared light path in the feed direction, and a splitter for splitting the light from the shared light path into light directed from the first light source to the first objective lens and light directed from the second light source to the second objective lens. Merging the light from the first light source and the light from the second light source into the shared light path in the feed direction can reduce the dimension in the direction (Y direction) orthogonal to both the disc axis direction and feed direction.

(3) The optical system of the optical pickup device includes a spherical aberration correction lens disposed in the shared light path to correct spherical aberration. This enables light from both the first and second light sources to share the spherical aberration correction lens, which can make the optical pickup device smaller. The configuration in which the first and second objective lenses, the spherical aberration correction lens, and the first light source are disposed on a line passing through the rotational axis of the optical disc and parallel to the feed direction when seen from the disc axis direction also enables the dimension of the optical pickup device orthogonal to both the disc axis direction and the feed direction to be reduced.

(4) The second light source is disposed adjacent to the first light source in the direction (Y direction) orthogonal to both the disc axis direction and feed direction. The dimension in the direction (Y direction) orthogonal to both the disc axis direction and feed direction and the dimension (thickness) in the disc axis direction (Z direction) can thereby be reduced.

(5) The movable part of the objective lens actuator has an upper part on which the first and second objective lenses are disposed, a first side part, and a second side part, and the upper part, first side part, and second side part bound a space extending in the feed direction, having an aperture directed toward the first light source. This enables light from the light source to be brought inside the movable part through its side aperture, which can reduce the dimension of the optical pickup device in the disc axis direction (the vertical direction dimension or thickness), compared with a configuration in which the light enters the movable part from below. Specifically, it is possible to vertically position the movable part of the objective lens actuator so that it is substantially in line with the position from which light exits the light source; thus the movable part can be disposed at a lower position than in a configuration in which the light enters from the bottom of the movable part, and the optical pickup device can be made thinner.

(6) The splitter includes a dichroic prism for reflecting light from one of the first and second light sources toward the corresponding one of the first and second objective lenses and transmitting light from the other light source, and a triangular mirror for reflecting light from the other light source that has passed through the dichroic prism toward the corresponding other one of the first and second objective lenses. The splitter can thereby be implemented in a compact size, resulting in a smaller optical pickup device.

(7) In the optical disc device of the swinging changer type, when seen from the disc axis direction, the first and second objective lenses are disposed at a position nearer to the first guide shaft disposed on the storage area side than to the second guide shaft disposed on the side opposite the storage area side. This can reduce the size of the optical disc device in the direction orthogonal to both the disc axis direction and feed direction. This will be described below with reference to FIG. 9.

As shown in FIG. 9, the lateral allowable width of the deck 200 is minimal at the position in the front-back direction where the storage area has maximal lateral width. The allowable lateral width of the deck 200 increases with increasing forward or backward distance from this front-back directional position. Accordingly, between the storage area 110 and the line LL passing parallel to the front-back direction through the leftmost allowable edge of the deck 200 at this front-back directional position, there is an expanding space S (the region indicated by hatching) available to the deck 200.

If the objective lenses 3, 4 (or the straight line LX) are disposed at a position closer to the guide shaft 231 than to the screw shaft 232 when seen from the disc axis direction, the spindle motor 212 and turntable 213 can be disposed so as to make use of this space S, thereby reducing the lateral width of the optical disc device 1000.

If, in contrast to the above configuration, the objective lenses 3, 4 (or the straight line LX) were to be disposed at a position closer to the screw shaft 232 than to the guide shaft 231, the turntable 213 and spindle motor 212 might intrude to the right of the screw shaft 232, and the edge (i.e., the right edge) of the deck 200 on the screw shaft 232 side might have to shift to the right as compared with the above configuration, so the lateral width of the optical disc device 1000 might increase.

(8) The objective lens actuator is configured so that the movable part is placed on the first guide shaft side and the support is placed on the second guide shaft side. This configuration enables the first and second objective lenses to be disposed at a position nearer to the first guide shaft than to the second guide shaft, which can reduce the dimensions of the optical disc device as described in (7) above.

(9) At least one of the first and second light sources (the second light source in the above example), when seen from the feed direction, has a substantially rectangular shape and is disposed such that the direction of narrow width of this shape is parallel to the information recording surface. This configuration makes it possible to reduce the dimension of the optical pickup device in the direction (Y direction) orthogonal to both the disc axis direction and feed direction. Specifically, by aligning a cylindrical package and a flat package in the Y direction as the first and second light sources in such a way that the direction of narrow width of the shape of the flat package is parallel to the information recording surface, it becomes possible to configure an optical pickup device having dimensions within the dimensions prescribed for realizing the optical disc device 1000 (specifically, for mounting in the deck 200).

### Second Embodiment

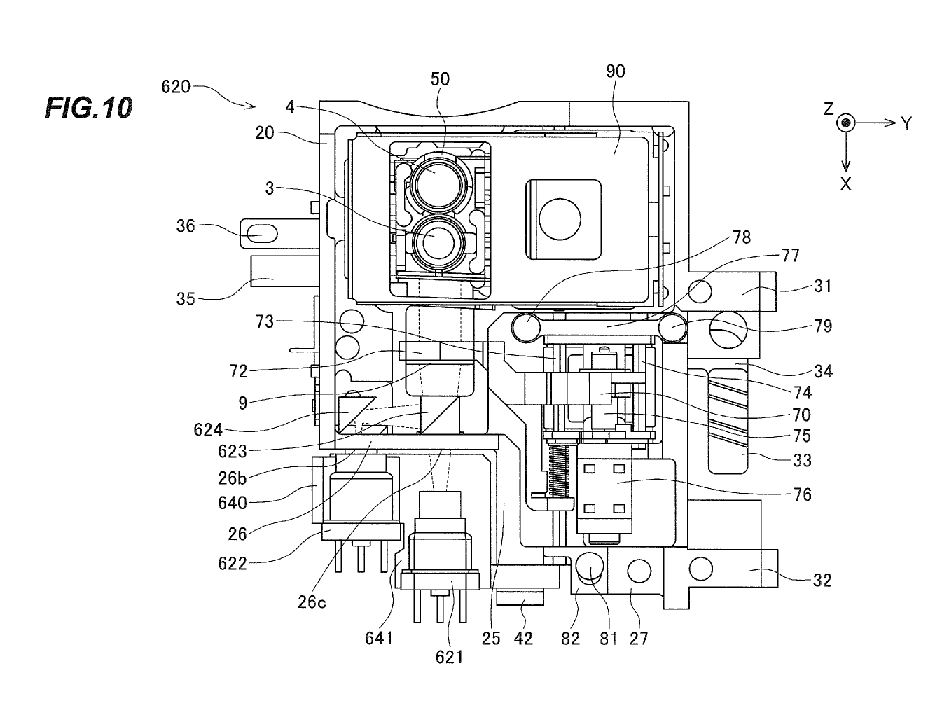

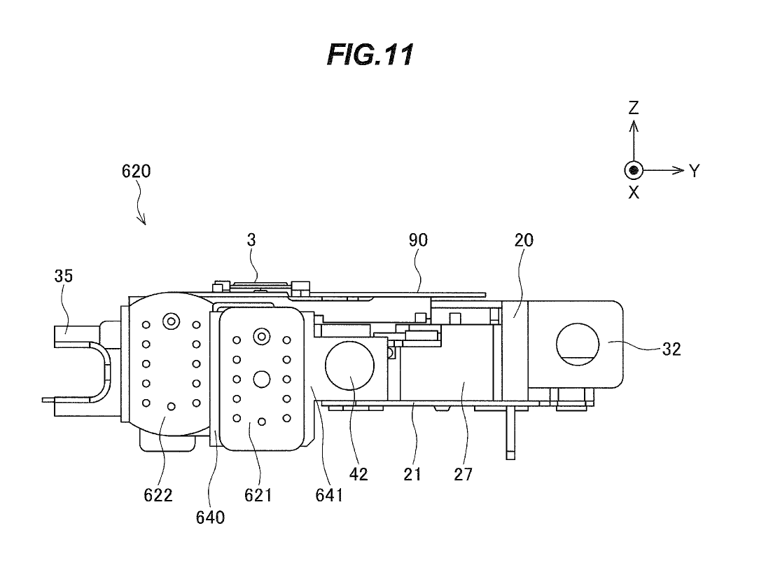

FIGS. 10 and 11 are respectively a top view and a rear view showing an example of the configuration of the optical pickup device 620 in the second embodiment. This optical pickup device 620 is nearly identical to the one in the first embodiment, so parts that are the same as in the first embodiment have the same reference characters, and descriptions thereof will be omitted or simplified.

In this embodiment, the optical pickup device 620 has a BD hologram laser unit 621 as its first light source and a DVD/CD hologram laser unit 622 as its second light source.

The BD hologram laser unit 621 is a unit incorporating a laser element for emitting BD laser light, a photodetector for receiving light returning from the BD, and a hologram element (for signal detection) that guides the returning light from the BD to the photodetector. That is, the BD hologram laser unit 621 has the functions of both emitting and receiving laser light; to make it perform both functions it is equipped with a (small) prism. For this reason, the package shape of the BD hologram laser unit 621 is substantially rectangular when seen from the feed direction (X direction). The BD hologram laser unit 621 is disposed so that the narrow width (short sides) of this shape is parallel to the information recording surface of the optical disc and the wide width (long sides) is perpendicular to the information recording surface of the optical disc.

The DVD/CD hologram laser unit 622 is a unit incorporating a laser element for emitting DVD laser light and CD laser light, a photodetector for receiving light returning from the DVD or CD, and a hologram element (for signal detection) that guides the returning light from the DVD and CD to the photodetector. That is, the DVD/CD hologram laser unit 622 has functions of both emitting and receiving laser light; to make it perform both functions it is equipped with a (small) prism. For this reason, the package shape of the DVD/CD hologram laser unit 622 is substantially rectangular when seen from the feed direction (X direction). The DVD/CD hologram laser unit 622 is disposed so that the narrow width (short sides) of this shape is parallel to the information recording surface of the optical disc and the wide width (long sides) is perpendicular to the information recording surface of the optical disc.

The configuration and operation of the BD optical system of the optical pickup device 620 are as follows. The BD optical system configuration includes the BD hologram laser unit 621, a combining prism 623, the spherical aberration correction lens 9, the dichroic prism 14 (not shown), and objective lens 3.

The BD hologram laser unit 621 is disposed so as to emit light in the −X direction (feed direction); the BD hologram laser unit 621, combining prism 623, spherical aberration correction lens 9, and dichroic prism 14 are aligned, in this order in the direction of light propagation, on a straight line extending in the X direction.

The BD laser light emitted from the BD hologram laser unit 621 passes through the combining prism 623 and is focused on the information recording surface of the BD via the spherical aberration correction lens 9, dichroic prism 14, and objective lens 3. The returning light reflected by the information recording surface of the BD enters the combining prism 623 via objective lens 3, dichroic prism 14, and spherical aberration correction lens 9, passes through the combining prism 623, and then enters the photodetector in the BD hologram laser unit 621.

The configuration and operation of the DVD and CD optical system for the optical pickup device 620 are as follows. The DVD and CD optical system configuration includes the DVD/CD hologram laser unit 622, a folding mirror 624, the combining prism 623, and the spherical aberration correction lens 9, dichroic prism 14 (not shown), triangular mirror 15 (not shown), and objective lens 4.

The DVD/CD hologram laser unit 622 is disposed so as to emit light in a direction identical to the direction (−X direction) of light emitted from the BD hologram laser unit 621, and the height of the exit position of the light (i.e., the position in the Z direction) is the same as the height of the exit position of the light from the BD hologram laser unit 621. The folding mirror 624 is disposed on the −X side of the DVD/CD hologram laser unit 622 and to the −Y side of the combining prism 623.

The DVD or CD laser light emitted from the DVD/CD hologram laser unit 622 is folded at a right angle in the +Y direction by the folding mirror 624, and further folded at a right angle in the −X direction by the combining prism 623. That is, the folding mirror 624 and combining prism 623 bring the light path of the DVD or CD laser light from the DVD/CD hologram laser unit 622 in line with the light path of the BD laser light. The DVD or CD laser beam exiting the combining prism 623 is focused on the information recording surface of the DVD or CD via the spherical aberration correction lens 9, dichroic prism 14, triangular mirror 15, and objective lens 4. The returning light reflected from the information recording surface of the DVD or CD enters the photodetector in the DVD/CD hologram laser unit 622 via the triangular mirror 15, dichroic prism 14, spherical aberration correction lens 9, combining prism 623, and folding mirror 624.

To describe the specific configuration of the optical pickup device 620, the light source unit 640 in this embodiment has a light source unit holder 641, to which the BD hologram laser unit 621 and DVD/CD hologram laser unit 622 are secured. The light source unit holder 641, like the light source unit holder 41 in the first embodiment, is secured to the base 20 with a screw 42. The portion of rear side part 26 of the base 20 facing the BD hologram laser unit 621 and the portion facing the DVD/CD hologram laser unit 622 have respective holes 26b and 26c formed therein.

The descriptions that apply to the size of the optical pickup device 620 are the same as the descriptions applied to the size of the optical pickup device 220 in the first embodiment. The optical pickup device 620 is mountable in the optical disc device 1000 in place of the optical pickup device 220.

In addition to the foregoing effects (1) to (8), the following effect (10) can be obtained from the second embodiment described above.

(10) Both the first and second light sources have a substantially rectangular shape when seen from the feed direction, and are disposed in such a way that the narrow width of the shape is parallel to the information recording surface. This configuration can reduce the dimension of the optical pickup device in the direction (Y direction) orthogonal to both the disc axis direction and feed direction. Specifically, by aligning two flat packages as the first and second light sources in the Y direction such that the narrow width of each of the shapes is parallel to the information recording surface, it becomes possible to configure an optical pickup device having dimensions within the dimensions prescribed for realizing the optical disc device 1000 (specifically, for mounting in the deck 200).

### Third Embodiment

The optical pickup device in a third embodiment will be described below. This optical pickup device is nearly identical to the one in the first embodiment, so parts that are the same as in the first embodiment have the same reference characters, and descriptions thereof will be omitted or simplified.

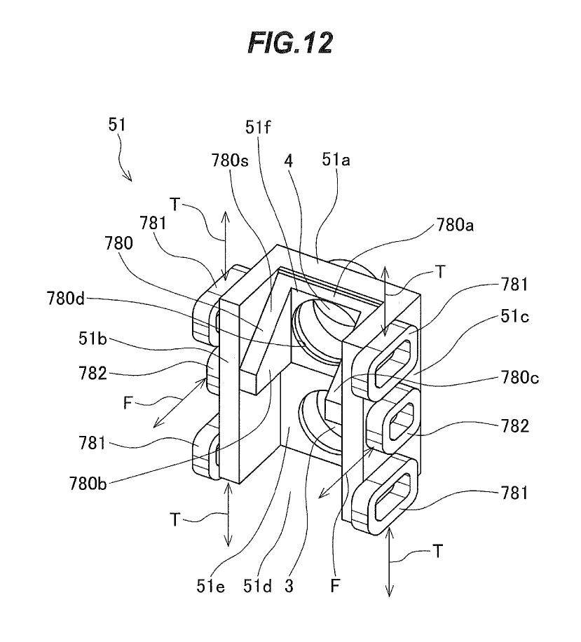

FIG. 12 is a perspective view showing the configuration of the movable part 51 of the objective lens actuator 50 in the third embodiment.

As shown in FIG. 12, the movable part 51 has an upper part 51a facing the information recording surface of the optical disc, a first side part 51b extending in the direction (−Z direction) away from the information recording surface from the end of the upper part 51a on the support 53 side, and a second side part 51c extending in the direction (−Z direction) away from the information recording surface from the end of the upper part 51a on the side opposite the support 53 side. The objective lenses 3, 4 are mounted on the upper part 51a. The movable part 51 also has tracking coils 781 and focus coils 782, which are electromagnetic coils for actuating the movable part 51 in the focus direction and tracking direction, respectively. The tracking coils 781 and focus coils 782 are disposed on the outer sides of the first side part 51b and second side part 51c, that is, on the two Y-directional sides of the movable part 51. Specifically, tracking coils 781 are disposed at both X-directional (feed-directional) ends of the first side part 51b and second side part 51c and focus coils 782 are disposed at their X-directional centers.

The upper part 51a, first side part 51b, and second side part 51c (referred to below as the main body of the movable part 51) bound a space 51e extending in the X direction with apertures 51d and 51f at both ends in the X direction; in cross-sectional view in a plane perpendicular to the X direction, the main body of the movable part 51 has a U-shape open at the bottom. The space 51e constitutes a light path that receives light exiting the spherical aberration correction lens 9 in the −X direction through opening 51d and takes the light to the objective lenses 3, 4. That is, the movable part 51 is configured in such a way that light from the light sources 1 and 2 enters through the opening 51d facing light source 1 (i.e., facing away from the disc axis). Specifically, optical components for guiding light from the light sources 1, 2 to the objective lenses 3, 4 are disposed in the space 51e; these optical components guide the light produced by the light sources 1, 2 from the spherical aberration correction lens 9 to the respective objective lenses 3, 4. The specific optical components are the splitter 8, the dichroic prism 14 here disposed directly below objective lens 3, and the triangular mirror 15 disposed directly below objective lens 4.

A requirement on the movable part 51 from the viewpoint of servo stability etc. is that structural resonances in the frequency band from 10 kHz to 50 kHz must be suppressed to low levels. In order to guide light beams from opening 51d to the objective lenses, the movable part 51 has a U-shaped cross-sectional structure, but this structure has a general tendency to produce strong resonances due to natural vibration modes. Specifically, strong torsional mode resonances due to the actuating force of the tracking coils 781 and strong bending mode resonances in the open direction of the U shape due to the actuating force of the focus coils 782 are likely to occur. For example, referring to FIG. 12, the tracking coils 781 generate actuating force in the direction of arrows T in the drawing (the X direction), and excite a torsional mode resonance in which the first side part 51b and second side part 51c deform in the direction of the arrows T in mutually opposite phase; this is a type of natural vibration mode. The focus coils 782 generate an actuating force in the direction of arrow F (Z direction), exciting a bending mode resonance that narrows and widens the distance between the first side part 51b and second side part 51c. Such torsional mode and bending mode resonances become factors hampering servo stability.

A means of suppressing lower order resonances is to provide increased structural stiffness with respect to the direction of deformation in the resonance mode, so that the deformation does not become large.

In order to increase its stiffness with respect to resonance modes, the objective lens actuator 50 in this embodiment is provided with a projecting part (also referred to as an internal holder) 780 on the movable part 51, so that the movable part 51 does not have a simple U-shaped cross-sectional structure. The projecting part 780 has a continuous structure that extends across the rear surface of side part 51b (the surface facing the space 51e), the rear surface of the upper part 51a (the surface facing the space 51e), and the rear surface of side part 51c (the surface facing the space 51e) and projects into the space 51e. Specifically, the projecting part 780 has a flat plate part 780a extending across (or contacting) the rear surface of the upper part 51a, a projecting part 780b extending onto (or contacting) the rear surface of side part 51b, and a projecting part 780c extending onto (or contacting) the rear surface of the side part 51c. The center of the flat plate part 780a has a circular hole 780d through which light passes to objective lens 4.

The projecting part 780 also has a sloping surface 780s for avoiding interference with the optical components disposed within the space 51e to guide light from the light sources 1, 2 to the objective lenses 3, 4. In the example in FIG. 12, the projecting part 780 is disposed on the rear surface of the part of the upper part 51a that holds objective lens 4 and the sloping surface 780s is formed so as to avoid interference with the triangular mirror 15 directly below objective lens 4. Specifically, the sloping surface 780s is formed so as to slant obliquely downward on the side opposite the direction of incidence of light from the light sources 1 and 2, and has a slope of 45 degrees with respect to the X direction and Z direction. When seen from the Y direction, the projecting part 780 has a substantially triangular shape with one side parallel to the X direction, one side parallel to the Z direction, and one side disposed at an angle of 45 degrees with respect to the X direction and Y direction.

The projecting part 780 may be made from, for example, the same material as the main body of the movable part 51: for example, from the same liquid crystal polymer (LCP) as the main body of the movable part 51.

The projecting part 780 may be adhesively secured to the main body of the movable part 51, or may be integrally molded with the main body, using a metal mold.

In one aspect, the projecting part 780 is molded by using polyphenylene sulfide (PPS) or an LCP with enhanced thermal conductivity and is adhesively secured to the main body of the movable part 51. In this case, the temperature gradient of the upper part 51a to which the objective lenses are secured can be reduced, enabling variations of optical characteristics caused by the temperature gradient of the objective lens to be reduced; this makes it possible, for example, to omit the temperature compensation function in the control scheme of the optical pickup device.

In addition to the foregoing effects (1) to (9), the following effect of (11) can be obtained from the third embodiment described above.

(11) The movable part 51 further includes a projecting part, which is a continuous projection extending across the rear surface of the first side part, the rear surface of the upper part, and the rear surface of the second side part, projecting into the space, and having a sloping surface for avoiding interference with the optical components disposed within the space that guide light from the first and second light sources to the first and second objective lenses. With this structure, the amplitudes of torsional mode and bending mode resonances can be reduced and stable servo characteristics can be obtained. Specifically, stiffness with respect to torsional and bending deformation is improved and torsional and bending deformation is suppressed, resulting in reduced resonance.

The movable part in the third embodiment may be used in the optical pickup device 620 in the second embodiment.

### Fourth Embodiment

The optical pickup device in the fourth embodiment will be described below. This optical pickup device is nearly identical to the one in the first embodiment, so parts that are the same as in the first embodiment have the same reference characters, and descriptions thereof will be omitted or simplified.

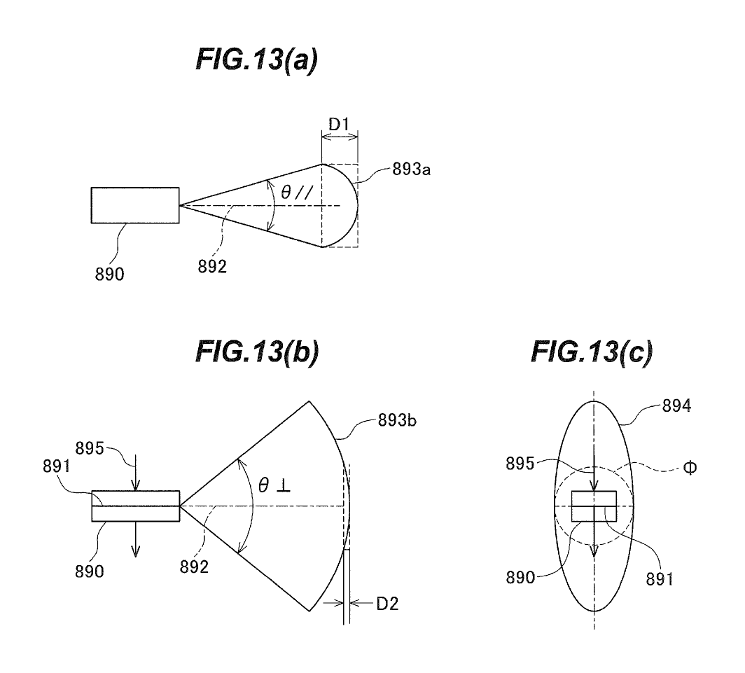

FIGS. 13(a) to 13(c) are diagrams showing a semiconductor laser (laser diode) 890 mounted in light source 1 and the radiation intensity distribution of its outgoing laser light. FIG. 13(a) shows the profile seen from the direction perpendicular to the junction surface (also referred to as the junction interface) 891 of the semiconductor laser 890; FIG. 13(b) shows the profile seen from the direction parallel to the junction surface 891 of the semiconductor laser 890 and perpendicular to the optical axis 892 of the outgoing light; FIG. 13(c) shows the profile seen from the direction of the optical axis 892.

FIG. 13(a) shows a radiation intensity distribution 893a and a radiation angle (horizontal radiation angle) θ// in the direction parallel to the junction surface 891 of the semiconductor laser 890. FIG. 13(b) shows a radiation intensity distribution 893b and a radiation angle (vertical radiation angle) θ⊥ in the direction perpendicular to the junction surface 891 of the semiconductor laser 890. FIG. 13(c) shows the cross-sectional shape 894 of the light beam exiting the semiconductor laser 890.

As shown in FIG. 13, when driving current 895 is caused to flow through the semiconductor laser 890, because of the nature of light, a laser beam having an elliptically-shaped cross section 894 is output; the radiation intensity distribution 893a in the direction parallel to the junction surface 891 of the semiconductor laser 890 is narrow (i.e., the horizontal radiation angle θ// is small); the radiation intensity distribution 893b in the direction perpendicular to the junction surface 891 of the semiconductor laser 890 is wide (i.e., the vertical radiation angle θ⊥ is large).

The optical system in the optical pickup device 220 is configured so as to select the central circular region Φ in the elliptical outgoing beam shown in FIG. 13(c) and guide the light in region Φ to objective lens 3, which focuses the light onto the optical disc. Specifically, the optical system of the optical pickup device 220 is configured with a diaphragm structure (aperture) in front of the spherical aberration correction lens 9 that selects region Φ from the outgoing light before the light enters the spherical aberration correction lens 9. At this time, if a comparison is made in the selected cross section, the intensity variation D2 in the radiation intensity distribution 893b in the direction perpendicular to the junction surface 891 is small, and the intensity variation D1 in the radiation intensity distribution 893a in the direction parallel to the junction surface 891 is large. When the beam is focused by the objective lens, a sharply-defined spot shape with little blurring is obtained in the perpendicular direction, in which the intensity variation is small, and a poorly delineated spot shape with blurred boundaries is obtained in the parallel direction, in which the intensity variation is large.

The semiconductor laser mounted in light source 2 also outputs a laser beam having an elliptically-shaped cross section, in which the radiation intensity distribution in the direction parallel to the junction surface is narrow (i.e., the horizontal radiation angle θ// is small) and the radiation intensity distribution in the direction perpendicular to the junction surface is wide (i.e., the vertical radiation angle θ⊥ is large). The optical system of the optical pickup device 220 is configured to select the central circular region of the beam exiting the semiconductor laser in light source 2 and guide the beam to objective lens 4, which focuses the light onto the optical disc.

When the laser spot focused on a data pit train on the optical disc is traced, in order to obtain high jitter performance, it is desirable to be able to detect light intensity variations in the direction of progression of the data pits distinctly.

In this embodiment, from the viewpoint of obtaining high jitter performance in reproduction, light source 1 and light source 2 are both configured in such a way that the direction in which the radiation angle of the laser light from the semiconductor laser included in the light source is wide (specifically, the direction perpendicular to the junction surface) and the direction (Y direction in FIG. 5) of the data pit train on the optical disc are identical. Specifically, light source 1 and light source 2 are disposed in such a way that the direction in which the radiation angle of the laser light is wide (specifically, the direction perpendicular to the junction surface) is parallel to the information recording surface of the optical disc.

In addition to the foregoing effects (1) to (9), the following effect of (12) can be obtained from the fourth embodiment described above.

(12) The optical axis of the light emitted from the first light source is on the straight line LX when seen from the direction of the disc axis of rotation, and the optical axis of the light emitted from the second light source is disposed parallel to the optical axis of the light emitted from the first light source. The first and second light sources both have laser beam radiation angles that differ in two mutually orthogonal directions, and the one of the two directions which has a wider radiation angle is disposed parallel to the information recording surface of the optical disc. This configuration makes it possible to obtain high jitter performance in reproduction, thereby improving the performance of the optical disc device.

By placing a small-diameter cylindrical package and a flat package as the first and second light sources side by side in the Y direction in such a way that the direction of narrower width of the shape of the flat package is parallel to the information recording surface, and by disposing the first and second light sources in such a way that the direction in which the laser beam radiation angle is wider is parallel to the information recording surface, an optical pickup device with small size and high reproduction performance can be configured.

The configuration in the fourth embodiment may be used in the optical pickup device 620 in the second embodiment. In this case, the BD hologram laser unit 621 and DVD/CD hologram laser unit 622 are both configured in such a way that the direction in which the radiation angle of the laser beam exiting the semiconductor laser included in the unit is wider (specifically, the direction perpendicular to the junction surface) and the direction (Y direction in FIG. 10) of the data pit trains on the optical disc are identical. Specifically, the BD hologram laser unit 621 and DVD/CD hologram laser unit 622 are both disposed in such a way that the direction in which the radiation angle of the laser light is wider (specifically, the direction perpendicular to the junction surface) is parallel to the information recording surface of the optical disc.

The configuration in the fourth embodiment may also be used in the optical pickup device in the third embodiment.

The present invention is not limited to the embodiments described above; it can be practiced in various other aspects without departing from the inventive scope.

For example, the optical systems of the optical pickup devices 220 and 620 are not limited to the systems described in the embodiments above; optical components may be added, removed, or altered as necessary. For example, spherical aberration may be corrected by moving a beam expander lens instead of a collimator lens. That is, the spherical aberration correction lens may be a beam expander lens, or another type of lens. As an alternative to using a spherical aberration correction lens to correct spherical aberration, a liquid crystal element may be used. When spherical aberration need not be corrected, the means for correcting spherical aberration may be omitted. In the above embodiments, when seen from the first light source, among the first and second objective lenses, the first objective lens is disposed on the nearer side, but the second objective lens may be disposed on the nearer side instead.

The above description shows an example in which the optical pickup device is applied in a 1-DIN-size optical disc device of the deck swinging changer type usable with three types of optical discs (BD/DVD/CD), but the optical pickup device is applicable not only to this but also to other types of optical disc devices.

### REFERENCE CHARACTERS

1 first light source, 2 second light source, 3 first objective lens, 4 second objective lens, 5 optical system, 6 shared optical path, 7 combiner, 8 splitter, 9 spherical aberration correction lens, 11 diffraction grating, 12 combining prism, 13 waveplate, 14 first folding mirror (dichroic prism), 15 second folding mirror (triangular mirror), 16 cylindrical lens, 17 photodetector, 20 base, 40 light source unit, 41 light source unit holder, 50 objective lens actuator, 51 movable part, 51a upper part, 51b first side part, 51c second side part, 51d, 51f aperture, 51e space, 52a-52f wire, 53 support, 70 spherical aberration correction apparatus, 100 magazine, 110 storage area, 120 optical disc transport mechanism, 200 deck, 210 optical disc rotating mechanism, 211 axis of rotation, 212 spindle motor, 212a spindle, 213 turntable, 220 optical pickup device, 231 first guide shaft (guide shaft), 232 second guide shaft (screw shaft), 240 shaft turning mechanism, 241 stepping motor, 250 deck base, 260 deck axis of rotation, 300 deck swinging mechanism, 400 chassis, 620 optical pickup device, 621 BD hologram laser unit, 622 DVD/CD hologram laser unit, 623 combining prism, 624 folding mirror, 780 projecting part, 780s sloping surface, 781 tracking coil, 782 focus coil, 890 semiconductor laser, 891 junction surface, 900 optical disc, 1000 optical disc device.

1. An optical pickup device that moves in a feed direction parallel to a radial direction of an optical disc rotating around an axis of rotation, and records or reproduces information on an information recording surface of the optical disc, the optical pickup device comprising:
a first light source for emitting light of a first wavelength, the first light source being an optical component;
a second light source for emitting light of a second wavelength differing from the first wavelength, the second light source being an optical component separate from the first light source;
a first objective lens for focusing the light from the first light source onto the information recording surface;
a second objective lens for focusing the light from the second light source onto the information recording surface; and
an optical system for guiding the light from the first and second light sources to the first and second objective lenses, respectively; wherein
the first and second objective lenses and the first light source are disposed in a plane that passes through the axis of rotation and is parallel to the feed direction;
the second light source is disposed adjacent the first light source in a direction perpendicular to the plane that passes through the axis of rotation and is parallel to the feed direction, and is disposed in such a way that the light emitted from the second light source and the light emitted from the first light source are emitted in mutually identical directions;
at least one of the first light source and the second light source emits an elliptical beam of light and is disposed in such a way that a direction with a wide radiation angle of the elliptical beam of light is oriented parallel to the information recording surface.

2-8. (canceled)

9. The optical pickup device of claim 1, wherein at least one of the first light source and the second light source is a semiconductor laser in a flat package having, when seen from the feed direction, a substantially rectangular external shape, and is disposed in such a way that a narrow width direction of the external shape is oriented parallel to the information recording surface.

10. The optical pickup device of claim 9, wherein the semiconductor laser in the flat package is a dual wavelength semiconductor laser for emitting laser light with a wavelength of 680 nm and laser light with a wavelength of 780 nm.

11. The optical pickup device of claim 1, wherein at least one of the first light source and the second light source is a hologram laser unit including a laser element for emitting the light, a photodetector for receiving light returning from the information recording surface, and a hologram element for guiding the light returning from the information recording surface to the photodetector, the hologram laser unit having, when seen from the feed direction, a substantially rectangular external shape, the hologram laser unit being disposed in such a way that a narrow width direction of the external shape is oriented parallel to the information recording surface.

12. An optical disc device comprising:
an optical disc rotating unit onto which the optical disc is loaded and which rotates the optical disc around the axis of rotation; and
the optical pickup device of claim 1, for recording or reproducing information on the optical disc rotating around the axis of rotation.

13. An optical disc device comprising:
an optical disc rotating unit onto which the optical disc is loaded and which rotates the optical disc around the axis of rotation; and
the optical pickup device of claim 9, for recording or reproducing information on the optical disc rotating around the axis of rotation.

14. An optical disc device comprising:
an optical disc rotating unit onto which the optical disc is loaded and which rotates the optical disc around the axis of rotation; and
the optical pickup device of claim 10, for recording or reproducing information on the optical disc rotating around the axis of rotation.

15. An optical disc device comprising:
an optical disc rotating unit onto which the optical disc is loaded and which rotates the optical disc around the axis of rotation; and
the optical pickup device of claim 11, for recording or reproducing information on the optical disc rotating around the axis of rotation.
